(19) United States
(12) Patent Application Publication
(10) Pub. No.: US 2021/0339427 A1
(43) Pub. Date: Nov. 4, 2021

(54) CONCRETE MIXER

(71) Applicant: EC MIX LTD, Colchester, Essex (GB)

(72) Inventors: Harry JURGENS, Sudbury (GB); William JURGENS, Sudbury (GB); Mark Hamilton JARDINE, Dedham (GB)

(73) Assignee: EC MIX LTD, Colchester, Essex (GB)

(21) Appl. No.: 17/286,583

(22) PCT Filed: Oct. 18, 2019
(86) PCT No.: PCT/GB2019/052986

§ 371 Date: Apr. 19, 2021

(30) Foreign Application Priority Data
Oct. 19, 2018 (GB) 1817067.0

(51) Int. Cl. B28C 5/08; B28C 5/16; B28C 5/18

(52) U.S. Cl. CPC B28C 5/0856; B28C 5/0893; B28C 5/1825; B28C 5/16

(57) ABSTRACT

A mixer for mixing concrete components comprises a chassis and a mixing drum mounted for rotation with respect to the chassis and having an open end. The chassis includes a lifting structure extending beyond the open end of the drum and a support structure spanning the open end of the drum. The mixer is moveable between an inverted orientation in which the open end of the mixing drum faces generally downwards and a mixing orientation in which the open end of the mixing drum faces generally upwards. The lifting structure is arranged to engage with a container with the mixer in the inverted orientation, and to lift and invert the container upon movement of the mixer to the mixing orientation. The support structure is arranged to support the inverted container above the mixing drum when the mixer is in the mixing orientation. Also, a method for producing a concrete mix.

### FIELD OF THE INVENTION

The invention relates to a mixer apparatus for mixing concrete and the like. In particular, but not exclusively, the invention relates to a concrete mixer capable of handling containers such as flexible intermediate bulk containers.

### BACKGROUND TO THE INVENTION

Concrete is produced by mixing aggregate with cement and water to form a slurry that can be poured and shaped into a desired form. The concrete hardens by hydration of the cement, forming a solid, stone-like material. Chemical admixtures are often added to the mix to modify various properties of the slurry or the resulting concrete.

To achieve acceptable quality and uniformity in the resulting concrete, and to meet specific criteria in relation to strength, setting time, workability and so on, the ratio of components in the mix must be carefully controlled, and the components must be mixed thoroughly before the concrete is poured. Both of these factors can be challenging to control, particularly in environments such as construction sites.

For small volumes, concrete can be mixed on-site using a portable concrete mixer comprising a rotating drum mounted on a portable chassis. Typically, the aggregate and cement are transferred manually to the drum by shovelling and water is added with a bucket or hosepipe. For larger volumes of concrete, this method is generally too labour-intensive. Furthermore, it can be difficult to control accurately the quantity of each component, leading to substantial variability in the properties of the resulting concrete.

An alternative approach is to deliver pre-mixed concrete, usually referred to as “ready-mix” concrete, to a construction site in a form that is ready to lay using an in-transit mixer truck. In-transit mixer trucks include a revolving mixing drum having mixing blades mounted on a truck body. Typically, an in-transit mixer truck is first loaded at a concrete plant with dry aggregate and cement, and suitable admixtures, and then a metered quantity of water is added. The components are mixed by rotation of the drum during transit to the construction site, and are then discharged at the site by rotating the drum in the opposite direction. Alternatively, the truck may be loaded with a pre-mixed concrete mixture including water, produced at a wet mix concrete plant, in which case the rotating drum of the mixer truck keeps the mixture agitated during transit.

Although ready-mix concrete delivered by an in-transit mixer can be more consistent than manually-mixed concrete in terms of the ratio of components in the mix, variability can still arise as a result of mixing time and therefore transit time from the concrete plant to the site.

Ready-mix concrete can also be supplied using volumetric concrete mixers. A volumetric concrete mixer is a truck-mounted device that stores the component materials in separate compartments and then mixes volumetrically-measured quantities of the components together after it arrives at the construction site. Whilst volumetric mixers eliminate variability due to transit time, volumetric measurement itself can introduce inconsistencies in the resulting concrete, for example due to settling and compaction of the granular components during transit.

Delivery of ready-mix concrete by either in-transit or volumetric mixer trucks is only possible when access for such trucks to the site is available, which is not always the case. Also, for practical and economic reasons, the concrete must be laid soon after the truck arrives on site, which may not always be convenient and can lead to logistical problems and construction delays.

For large projects where substantial volumes of concrete are required, portable or semi-portable batch plants can be set up at or close to the construction site. These units are able to produce large quantities of concrete with an accurate and reproducible mix, but are clearly impractical and not economically viable for smaller projects.

Against that background, it would be desirable to provide apparatus and methods for preparing quantities of mixed concrete in a convenient way on-site, and which offer improved accuracy in the mix of components.

### SUMMARY OF THE INVENTION

In a first aspect, the present invention provides a mixer for mixing concrete components, comprising a chassis and a mixing drum mounted for rotation with respect to the chassis and having an open end. The chassis includes a lifting structure extending beyond the open end of the drum and a support structure spanning the open end of the drum. The mixer is moveable between an inverted orientation in which the open end of the mixing drum faces generally downwards and a mixing orientation in which the open end of the mixing drum faces generally upwards. The lifting structure is arranged to engage with a container with the mixer in the inverted orientation, and to lift and invert the container upon movement of the mixer to the mixing orientation, and the support structure is arranged to support the inverted container above the mixing drum when the mixer is in the mixing orientation and to allow material to pass from the container into the mixing drum.

With this arrangement, the components required for a desired concrete mix, including quantities of cement, aggregates, and admixtures, can be pre-loaded into a container, which is preferably a flexible intermediate bulk container. The mixer can be manoeuvred to transfer the contents of the container into the drum, thereby avoiding manual lifting and shovelling, and the loading and mixing operation can be performed on-site at any convenient time.

By pre-loading the container with accurate quantities of material, and by eliminating other potential variations due to loading errors, mixing time, material settling and so on, the mixer can produce concrete having substantially greater conformity to desired properties than is achievable using traditional portable mixers or ready-mix deliveries, even with relatively small quantities of concrete.

The chassis may comprise at least one attachment point, such as a lifting eye, for attachment to the container. When the container is a flexible intermediate bulk container, the or each attachment point may be configured to for attachment to a lifting loop of the container. Preferably, the or each attachment point is disposed on an opposite side of the drum to the lifting structure, both to assist in lifting the container and, when the container is flexible, to hold the container open during lifting and transfer of the material into the drum. A pair of attachment points may be provided, which may be spaced apart laterally on a cross-member of the chassis. The cross-member may be disposed adjacent the closed end of the drum. One or more straps may be provided to attach the or each attachment point to the container, for example by attachment to one or more lifting loops of the container.

In another arrangement, the or each attachment point is disposed on the lifting structure. In such cases, the or each attachment point may therefore be disposed adjacent the open end of the drum. The lifting structure may comprise a lifting frame disposed at the open end of the mixing drum, and the or each attachment point may be disposed on the lifting frame.

When the container is a flexible intermediate bulk container, the chassis may further comprise guide members for supporting the lifting loops of the container. For example, the guides may be positioned so that the lifting loops can be routed around the guides to keep the container in an open configuration.

The lifting structure may comprise a plate for engaging a side of the container. The plate may be curved. The plate may provide a part-cylindrical surface for engagement with the container. Preferably, the plate in part extends adjacent to the mixing drum. The lifting structure may comprise a ramp for deflecting material from the plate into the mixing drum.

The lifting structure may comprise a chute for discharge of material from the mixer. For example, when the lifting structure comprises a curved plate, the plate may form the chute such that, when the mixer is tilted after mixing, the plate guides the flow of mixed material out of the drum.

To assist lifting of the container, the lifting structure may comprise a lifting foot for engaging a base of the container. For example, when the lifting structure comprises a curved plate, the lifting foot may extend radially inwardly from a free end of the plate.

The support structure may comprise a framework defining apertures through which the material can pass from the container into the mixing drum.

Preferably, the chassis comprises attachment means for attachment to an excavator arm. In this way, an excavator can be used to manoeuvre the mixer and, optionally, to power rotation of the mixing drum. This is particularly advantageous because excavators are commonplace on construction sites, and the mixer can be operated during times that the excavator and its operator would otherwise be idle to minimise delays to other construction work.

Accordingly, the invention extends, in a second aspect, to the combination of an excavator comprising an excavator arm, and a mixer according to the first embodiment of the invention, attached to the excavator arm by way of the attachment means.

In a third aspect, the invention provides a method for making a concrete mix, comprising engaging a mixer with a container containing cement and aggregate components of a concrete mix, manoeuvring the mixer to lift and invert the container using a lifting structure of the mixer, thereby to transfer the components into a mixing drum of the mixer, and rotating the mixing drum to mix the components.

The method may include pre-filling the container with the components.

The container may be a flexible intermediate bulk container. In this case, engaging the mixer with the container may comprise connecting at least one lifting loop of the container to the mixer. Lifting the container may comprise moving the container onto a support structure that spans an open end of the mixing drum.

The method may comprise, after transferring the components, removing the container from the mixer. The method may comprise, after mixing the components, manoeuvring the mixer to invert the mixing drum, thereby to discharge the concrete mix.

The mixer is preferably manoeuvred using an excavator arm.

Preferred and/or optional features of each aspect of the invention may also be used, alone or in appropriate combination, in the other aspects of the invention also.

### BRIEF DESCRIPTION OF THE DRAWINGS

Embodiments of the present invention will now be described, by way of example only, with reference to the accompanying drawings in which like reference numerals are used for like features, and in which:

FIG. 1 is a perspective view of a mixer according to the invention;

FIG. 2 is a side view of the mixer of FIG. 1;

FIG. 3 is a front view of the mixer of FIG. 1;

FIG. 4 is a cross-sectional view of the mixer of FIG. 1;

FIG. 5 shows the mixer of FIG. 1 in cross-section, mounted on an excavator arm, together with a flexible intermediate bulk container;

FIG. 6 is a side view of the mixer of FIG. 1 together with the flexible intermediate bulk container, showing a first stage in a method of using the mixer;

FIG. 7 is a side view of the mixer of FIG. 1 together with the flexible intermediate bulk container, showing a second stage in the method of using the mixer;

FIGS. 8(a), 8(b) and 8(c) are cross-sectional views of the mixer of FIG. 1 together with the flexible intermediate bulk container, showing third, fourth and fifth stages in the method of using the mixer;

FIG. 9 is a perspective view of another mixer according to the invention;

FIG. 10 is a side view of the mixer of FIG. 9;

FIG. 11 is a perspective view of the mixer of FIG. 9 with a lifting frame of the mixer in an extended position;

FIG. 12 is a side view of the mixer of FIG. 9 with the lifting frame in the extended position; and

FIGS. 13(a) and 13(b) are side views of the mixer of FIG. 9, with a flexible intermediate bulk container, showing first and second stages in a method of using the mixer.

### DESCRIPTION OF THE PREFERRED EMBODIMENTS

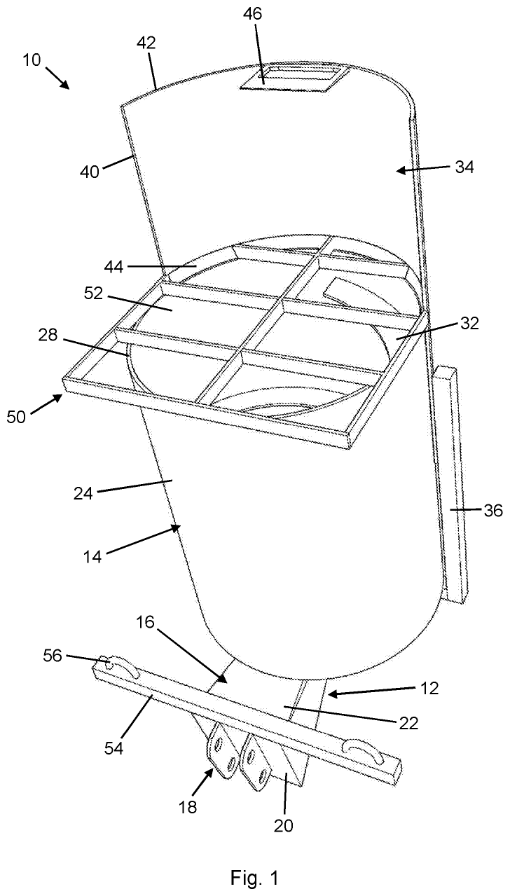

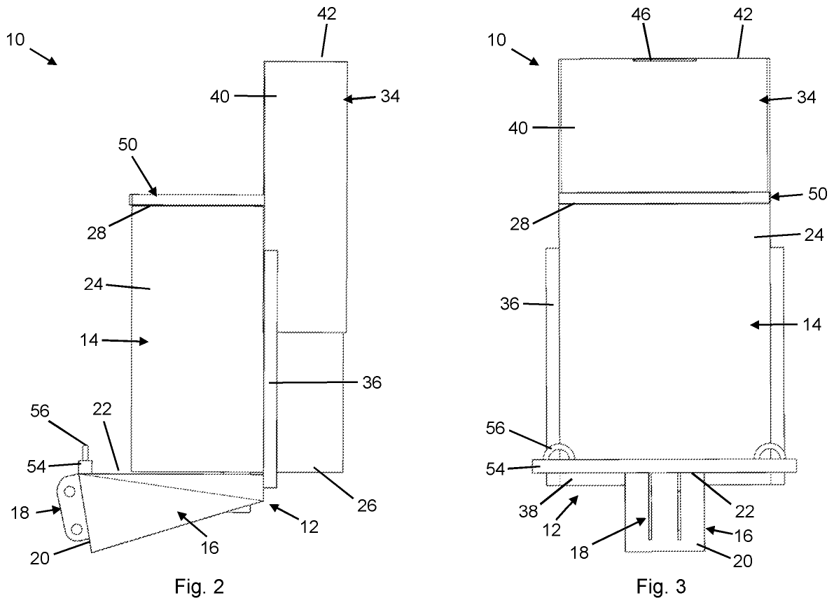

Referring to FIGS. 1 to 4, a mixer 10 according to an embodiment of the invention includes a chassis 12 and a mixing drum 14 mounted for rotation with respect to the chassis 12.

The chassis 12 has a base part 16 that includes an adaptor 18 at one end to allow the chassis 12 to be mounted to an excavator arm (not shown in FIGS. 1 to 4). The adaptor 18, which in this example comprises a pair of parallel adaptor plates, is attached to an end face 20 of the base part 16. The drum 14 is disposed adjacent to a top face 22 of the base part 16.

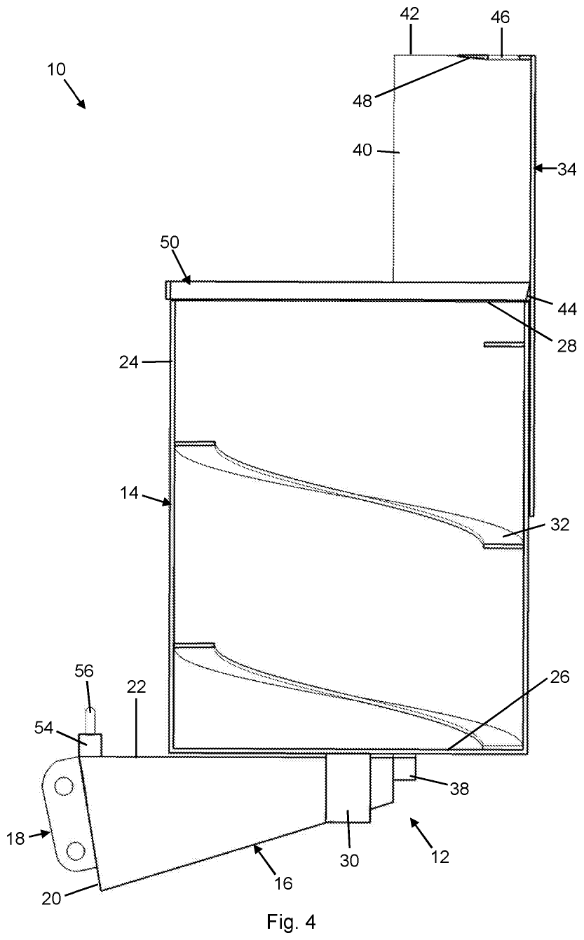

The drum 14 has a generally tubular wall 24 that extends from a base 26 to an open end 28 of the drum 14. As can be seen most clearly in FIG. 4, the base 26 of the drum 14 is mounted on an axle 30 that is rotatably mounted in the base part 16 of the chassis 12 and is driven for rotation by a suitable motor (not shown), housed in or on the base part 16 of the chassis 12. A helical mixing flighting or auger 32, shown in FIGS. 1 and 4, is affixed to the inside surface of the drum wall 24. In place of the auger, other features such as paddles or blades could be provided as are known in the art. In FIGS. 1 to 4, the mixer 10 is oriented in a mixing orientation, with the open end 28 of the drum 14 facing upwards.

The chassis 12 includes a lifting structure comprising a curved lifting plate 34 having a semi-cylindrical shape. The lifting plate 34 is disposed adjacent to one side of the wall 24 of the drum 14, and is held in place by a pair of arms 36 that extend from a first cross-member 38 that is, in turn, mounted to the end of the base part 16 of the chassis 12 opposite the adaptor 18 (see FIGS. 1 to 3). The shape of the plate 34 matches the contour of the wall 24 of the drum 14, and a small clearance between the plate 34 and the drum wall 24 allows rotation of the drum in either direction without fouling the plate 34. An extending part 40 of the plate 34 extends beyond the open end 28 of the drum 14 (upwardly in the mixing orientation of FIGS. 1 to 4) to a free edge 42 of the plate 34. A tapered ramp 44 is disposed on the inside surface of the plate 34 adjacent to the open end 28 of the drum 14, as can be seen in FIGS. 1 and 4.

A lifting foot 46, visible in FIGS. 1, 3 and 4, is provided adjacent to the free edge 42 of the lifting plate 34. The lifting foot 46 extends radially inwards from the plate 34, and the surface 48 of the foot 46 that faces towards the open end 28 of the drum 14 is tapered (as can be seen most clearly in FIG. 4).

The chassis 12 also includes a support structure 50 in the form of a metalwork frame that spans across the open end 28 of the drum. As shown in FIG. 1, the support structure 50 includes a plurality of openings 52 through which material can pass into and out of the mixing drum 14. The support structure 50 is joined to and supported by the lifting plate 34.

A second cross-member 54 is mounted on the top face 22 of the base part 16 of the chassis 12, adjacent to the end face 20 of the base part 16. Two lifting eyes 56 are fixed to the second cross-member 54 and are spaced laterally apart, with each lifting eye 56 disposed adjacent to a corresponding end of the second cross-member 54 on the side of the second cross-member 54 that faces away from the base part 16.

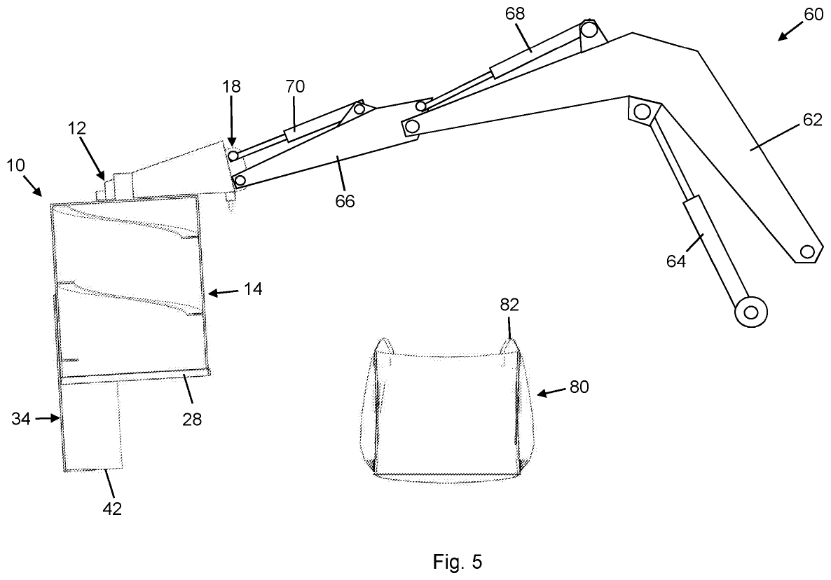

FIG. 5 shows the mixer 10 mounted on an excavator arm 60. As is known in the art, the excavator arm 60 comprises a boom 62 coupled at a first end to the excavator house (not shown). An associated hydraulic boom cylinder 64 is provided to pivot the boom 62 with respect to the house. The other, second end of the boom 62 is coupled to a first end of a stick or dipper arm 66, and an associated hydraulic stick cylinder 68 is provided to pivot the stick 66 with respect to the boom 62. The other, second end of the stick 66 is arranged to attach to the adaptor 18 of the mixer chassis 12, and a hydraulic attachment cylinder 70 is provided to pivot the chassis 12, and hence the mixer 10, with respect to the stick 66.

In FIG. 5, the excavator arm 60 is configured to hold the mixer 10 in an inverted orientation, with the open end 28 of the drum 14 facing generally downwards and the free end 42 of the lifting plate 34 lowermost.

FIG. 5 also shows a flexible intermediate bulk container (FIBC) 80, also known as a bulk bag, big bag or builder's bag. The FIBC 80 is of a type generally known in the art, and is of fabric construction. The FIBC 80 is square in plan, has an open top, and includes a lifting loop 82 at each top corner (only two of the lifting loops are shown in FIG. 5).

The FIBC 80 is pre-filled with the components required to form a concrete mix. The FIBC 80 therefore contains a suitable aggregate mix, a quantity of cement powder, and chemical admixtures. The amount of each component in the FIBC 80 is selected so that, when the components are mixed, concrete of a specified type and strength will be produced.

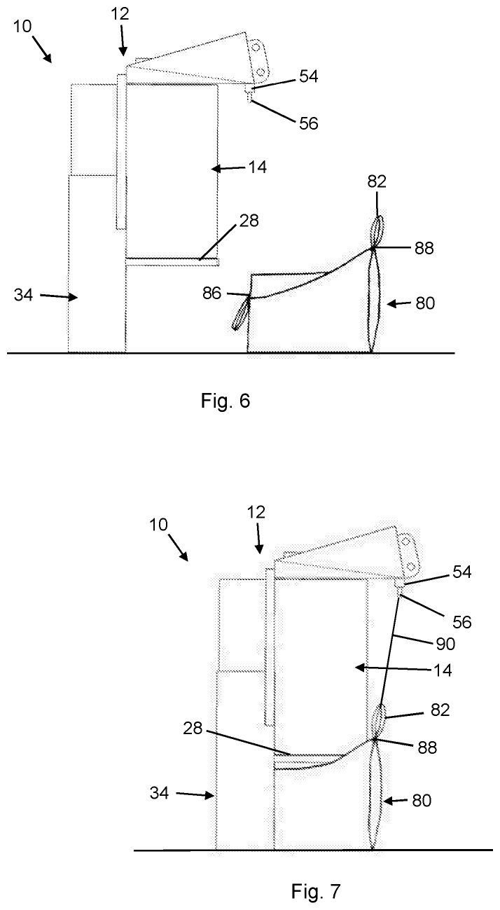

Operation of the mixer 10 will now be described with reference to FIGS. 6 to 8. During operation, the excavator arm 60 (not shown in FIGS. 6 to 8) is used to manoeuver the mixer 10 first to lift the FIBC 80 from the ground and then to empty the contents of the FIBC 80 into the drum 14.

First, referring to FIG. 6, the mixer 10 is positioned in the inverted orientation next to the FIBC 80, with the lifting plate 34 of the chassis 12 on the opposite side of the drum 14 to the FIBC 80. The top edge 86 of the FIBC 80 closest to the mixer 10 is folded over, leaving the opposite top edge 88, furthest from the mixer 10, unfolded.

The mixer 10 is then manoeuvred laterally to bring the lifting plate 34 into contact with the side of the FIBC 80, as shown in FIG. 7. In this position, the open end 28 of the drum 14 is positioned above the inside of the FIBC 80, and the lifting foot 46 (not visible in FIG. 7) slides under the base of the FIBC 80. The two lifting loops 82 on the unfolded edge 88 of the FIBC are then attached to the lifting eyes 56 on the chassis 12 using suitable webbing straps 90. The straps 90 are tensioned, for example by a ratchet mechanism (not shown) so that the lifting loops 82 and the unfolded edge 88 of the FIBC 80 are pulled upwards over the outside of the drum 14. As will be appreciated from FIG. 7, the second cross member 54 and the lifting eyes 56 are positioned so that the straps 90, the lifting loops 82, and the upper edge 88 of the FIBC 80 are held clear of the outer surface of the drum 14.

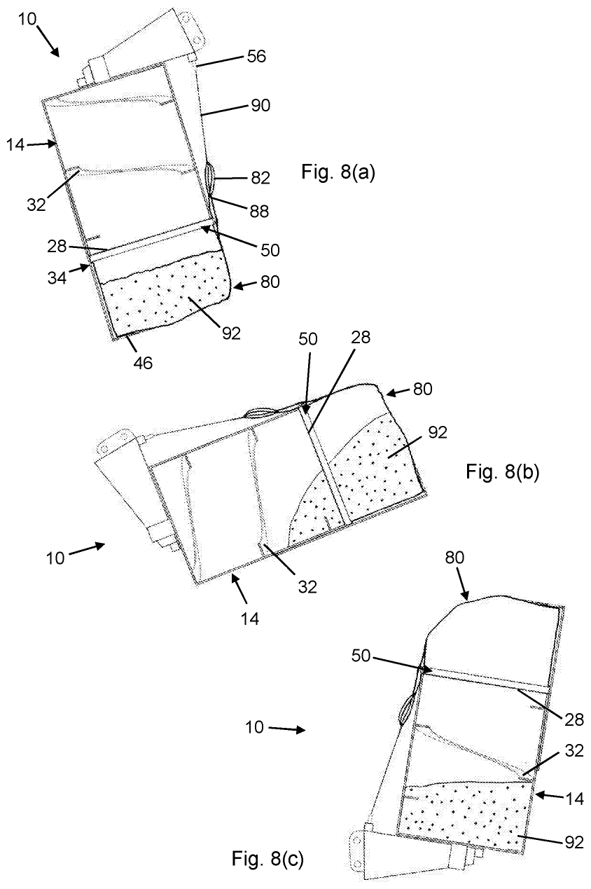

Next, the excavator arm 60 is operated to tilt the mixer 10 in such a way that the unfolded edge 88 of the FIBC 80 is raised up with respect to the folded edge 86, as shown in FIG. 8(a). In the example of FIG. 8(a), the tilting of the mixer 10 results in an anticlockwise rotation. At the same time, before or afterwards, the arm 60 is operated to lift the mixer 10 and the FIBC 80 clear of the ground. The lifting foot 46 and the lifting plate 34 act in combination to support one side of the FIBC 80 during lifting, while the lifting eyes 56, straps 90 and lifting loops 56 support the opposite side.

With the FIBC 80 clear of the ground, tilting of the mixer 10 continues in the same direction, as shown in FIG. 8(b), until the mixer 10 reaches a mixing orientation as shown in FIG. 8(c). During this manoeuvre, the FIBC 80 is lifted above the mixing drum 14 and inverted, so that the contents 92 of the FIBC 80 fall under gravity into the drum 14, through the apertures 52 in the support structure 50. The support structure 50 stops the FIBC 80 itself from dropping into the drum 14.

The curved shape of the lifting plate 34 helps to direct the material 92 from the FIBC 80 into the drum 14, so that the material 92 does not spill from the mixer 14. The tapered ramp 44 (see FIG. 4) on the lifting plate 34 deflects the material 92 into the drum 14 to help avoid material passing between the drum 14 and the lifting plate 34. The mixer 10 can be shaken or jerked using the excavator arm 60 if necessary to ensure that substantially all of the contents 92 of the FIBC 80 are transferred into the drum 14.

Once the material 92 has been transferred from the FIBC 80 into the drum 14, the empty FIBC 80 can be removed from the mixer 10. The motor can then be operated to turn the mixing drum 14 to mix the components in the drum 14, with the mixing auger 32 rotating with the drum 14 to aid mixing in a manner known in the art.

After mixing, the excavator arm 60 can be operated to re-invert the mixer 10, allowing the mixed concrete to be poured out of the mixer 10, using the curved lifting plate 34 as a chute to direct the mixed concrete into a desired location. By rotating the drum 14 in the appropriate direction during this operation, the mixing auger 32 can be used to help transfer the mixture out of the drum 14. Once empty, the mixer 10 can be cleaned by washing.

It will be appreciated that, in the mixing orientation of the mixer 10, the rotation axis of the mixing drum 14 need not be vertical, nor need there be a 180 degree rotation of the mixer 10 to switch between the mixing orientation and the inverted orientation. Similarly, in the inverted orientation, the rotation axis of the mixing drum 14 again need not be vertical. Instead, in the mixing orientation, the open end 28 of the drum 14 faces generally upwards and the lifting plate 34 extends above the mixing drum 14, and in the inverted orientation the open end 28 of the drum 14 faces generally downwards and the lifting plate 34 extends below the mixing drum 14.

The size of the mixer can be selected to produce volumes of mixed concrete that are suitable for a particular application. The dimensions of the mixer are preferably selected so that the mixer can be used with a particular size of FIBC and with a particular size of excavator. For example, the mixer may be dimensioned to operate with a “one tonne” FIBC bag, with typical dimensions of 900×900×900 mm. In such a case, the mixing drum has a capacity to mix approximately 1 m³ of concrete mix, and the mixer would be most conveniently used with a 5-tonne compact excavator. In another example, the mixer may be dimensioned to operate with a “half tonne” FIBC bag, with typical dimensions of 800×800×800 mm. In this example, the mixing drum has a capacity to mix approximately 0.5 m³ of concrete mix, and the mixer would be most conveniently used with a 2.5-tonne compact excavator.

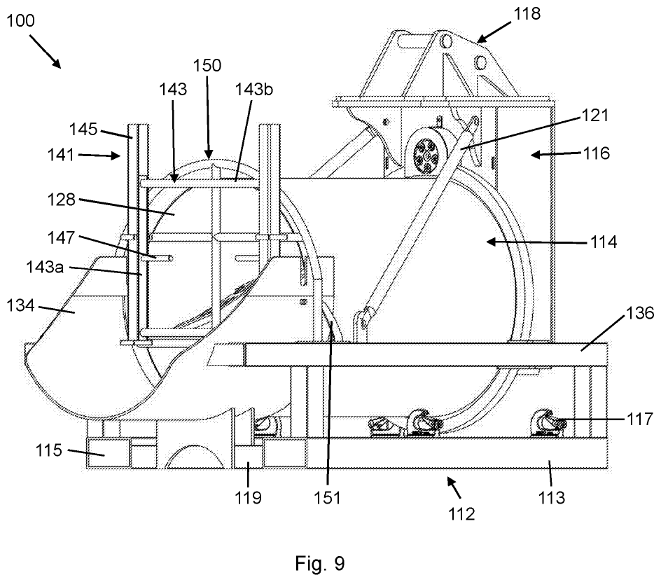

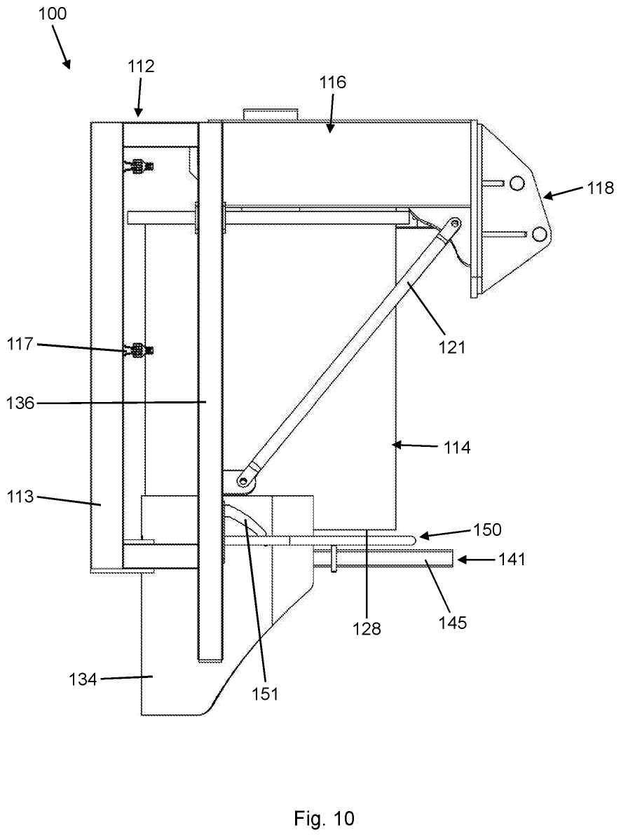

FIGS. 9 and 10 show a mixer 100 according to another embodiment of the invention. The mixer 100 is generally similar to the mixer 10 described above with reference to FIGS. 1 to 8, and only the differences will be described in detail. Features of the mixer 100 of FIGS. 9 and 10 that correspond to features of the mixer 10 of FIGS. 1 to 8 are provided with corresponding reference numerals incremented by 100.

As in the previously-described embodiment, the chassis 112 of the mixer 100 has a base part 116 upon which an excavator arm adaptor 118 is mounted. In this case, the chassis 112 also includes a pair of support rails 113 that extend parallel to one another and to the rotation axis of the mixing drum 114. The support rails 113 are disposed on one side of the drum 114, on the opposite side of the mixer 100 to the adaptor 118, so that the mixer 100 can be rested upon the support rails 113 when not in use as shown in FIG. 9. The support rails 113 are box-section and have open ends 115, and are suitably spaced apart to accommodate the tines of a fork lift vehicle. In this way, the mixer 100 can be moved either using a fork lift vehicle (using the fork tine holders provided by the support rails 113) or by an excavator (using the adaptor 118). Lifting hooks 117 are also affixed to each of the first support rails 113 to provide a further option for moving the mixer 100 using lifting straps. The lifting hooks 117 can also be used to lift and manoeuvre one or more containers.

The chassis 112 also includes a pair of arms 136, disposed adjacent and parallel to the support rails 113. Each of the arms 136 is attached at one end to the base 116 of the chassis 112, and extends alongside the drum 114 to project beyond the open end 128 of the drum 114. The other end of each arm 136 is attached to the outside of the curved lifting plate 134. The lifting plate 134 is also attached to a cross-member 119 that spans between the support rails 113. The chassis 112 is braced by a pair of bracing members 121 that extend between brackets mounted on the base 116 and the arms 136 of the chassis 112.

In this embodiment, the support structure 150 is mounted both to the lifting plate 134 and to the arms 136 of the chassis 112. Rigidity of the support structure 150 is enhanced by braces 151 that provide triangulation where the support structure 150 is attached to the arms 136.

The mixer 100 is provided with an additional lifting frame assembly 141 that forms part of the lifting structure, together with the lifting plate 134. The lifting frame assembly 141 is mounted across the open end 128 of the drum 114, with the support structure 150 positioned between the lifting frame assembly 141 and the drum 114.

The lifting frame assembly 141 comprises a generally square frame 143, formed by a pair of side members 143a and a pair of cross members 143b. The frame 143 is slidably mounted in a pair of tracks 145. The tracks 145 are U-shaped in cross section, with the open sides opposing one another across the open end 128 of the drum 114. The tracks 145 are suitably secured to the support structure 150. The frame 143 includes a pair of inwardly-extending bars 147 that project towards one another from the side members 143a of the frame 143. The bars 147 provide attachment point for the lifting loops of the FIBC. Suitable bearings (not shown) may be used to allow the frame 143 to slide easily with respect to the tracks 145.

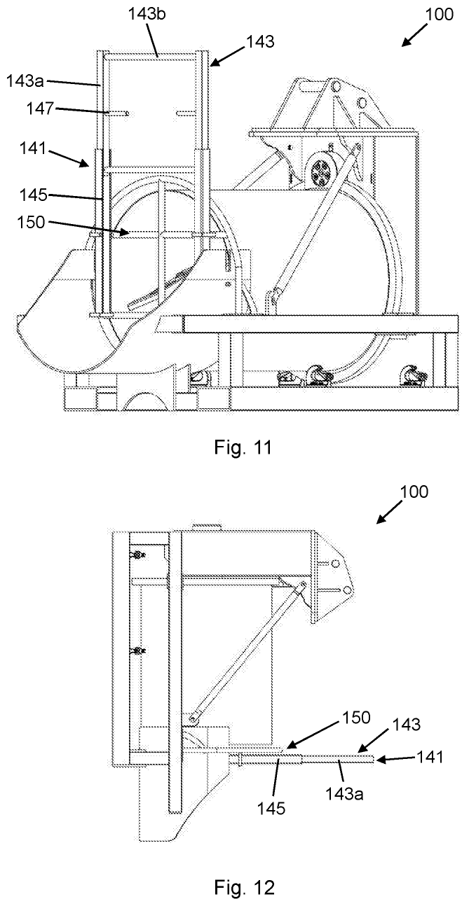

By sliding the frame 143 along the tracks 145, the lifting frame assembly 141 can be switched between a retracted configuration, in which the frame 143 is disposed substantially over the open end 128 of the drum 114, and an extended configuration, which is shown in FIGS. 11 and 12. In the extended configuration, the frame 143 is disposed an extended position so that the frame 143 does not overlap the open end 128 of the drum 114. Suitable stops (not shown) are used to prevent the frame 143 separating from the tracks 145 during movement into the extended position.

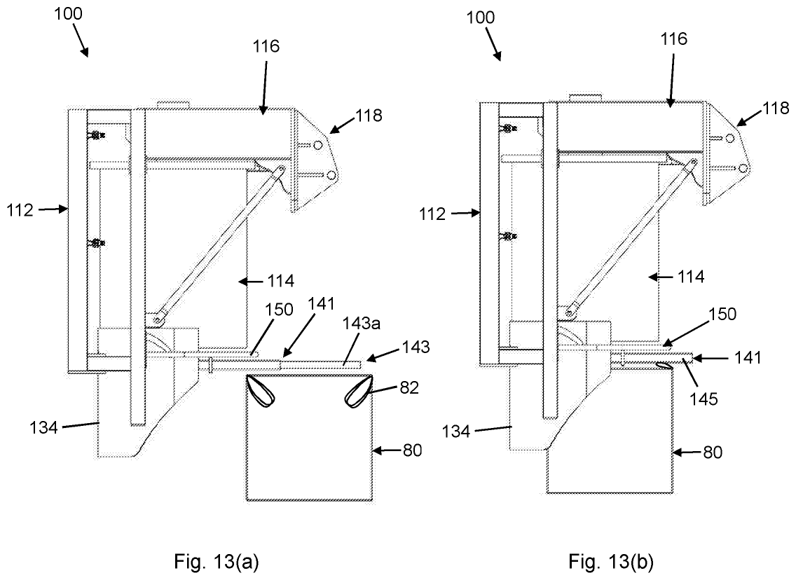

Referring to FIG. 13(a), in use, the mixer 100 can be attached to an excavator arm and manoeuvred into position next to an FIBC 80, with the mixer 100 in an inverted orientation. The lifting frame assembly 143 is set into the extended configuration. The mixer 100 is positioned such that, when the lifting frame 143 is its extended position, the lifting frame 143 is disposed substantially above the FIBC 80.

The lifting loops 82 of the FIBC 80 are then attached to the lifting frame 143. In one example, each loop 82 is passed over the nearest cross member 143b and then looped over the inwardly-extending bar 147 on the corresponding side of the frame 143. In this way, the cross members 143b act as guide members for the lifting loops 82 of the FIBC 80, such that, when the loops 82 are routed around the cross members 143b and looped over the bars 147, the FIBC 80 is held open by the lifting frame 143.

The lifting frame assembly 141 is then switched to the retracted configuration, as shown in FIG. 13(b). This can be done either by lifting the mixer 100 and sliding the lifting frame 143, with the FIBC 80 attached, into the retracted position, or by moving the mixer 100 relative to the FIBC 80 without lifting the FIBC 80.

Subsequent operation of the mixer 100 is substantially the same as described above with reference to the mixer 10 of FIGS. 1 to 8. In particular, the FIBC 80 can be lifted clear of the ground and the mixer 100 moved into a mixing orientation, so that the contents of the FIBC 80 pass through the support structure 150 (and the lifting frame 143) into the drum 114. After mixing, the mixed concrete can be poured out of the mixer 100 by re-inverting the mixer, with the empty FIBC 80 being removed before or after mixing.

In variants (not shown) of the mixer 100 of FIGS. 9 to 13, the lifting frame assembly 141 includes a mechanism that allows the lifting frame 143 and optionally the tracks 145 to be moved into a storage position alongside the drum. In this way, the lifting frame 143 and optionally the tracks 145 can be moved aside into the storage position to avoid mixed concrete falling onto the frame 143 and tracks 145, which could potentially obstruct or damage the bearings or other components. In one example, the lifting frame assembly 141 may be arranged to pivot through approximately 90 degrees from its extended position to the storage position.

Similarly, the support structure 150 could pivot or otherwise be moved away from the open end 128 of the drum 114 after the contents of the FIBC 80 have been transferred into the drum 114.

Mixers according to the invention may differ from those illustrated in several respects. For instance, the lifting structure may be of any suitable design. The lifting foot may be omitted from the mixer of FIGS. 1 to 8, or a lifting foot could be incorporated into the mixer of FIGS. 9 to 13. Multiple lifting feet could be provided instead of a single foot. In the illustrated embodiments, the lifting plate also acts as a chute to guide the material out of the mixing drum after mixing. However, the lifting plate need not form a chute and could conceivably be replaced with an open framework or with struts or the like. In this case, a separate chute could be provided to guide material into and out of the drum.

Similarly, the support structure could be of any suitable design. For example, instead of the framework in the illustrated embodiment, the support structure could be a mesh panel or a perforated panel. It is also possible that the support structure could be combined with or integral to the lifting structure.

The mixer may include any suitable attachment points to which the lifting loops of the FIBC can be attached, by straps or otherwise. For instance, instead of lifting eyes or bars, the attachment points could be in the form of hooks or slots. The attachment points could be provided on the lifting structure (as is the case for the mixer of FIGS. 9 to 13), on the support structure, or elsewhere on the chassis. In the mixer of FIGS. 1 to 8, the second cross member itself could provide attachment points where the straps are terminated with loops that can be slid over the cross member. The straps could be fixedly attached to the chassis, and could for example be provided on a retractable spool. Fewer or more than two attachment points could be provided, for example for use with FIBCs with fewer or more lifting loops on each side.

The mixer may include additional strengthening and bracing to prevent relative movement of the parts. For example, in the mixer of FIGS. 1 to 8, the end of the support structure closest to the end face of the base part of the chassis may be connected to the base part of the chassis, optionally by way of the second cross member, by suitable bracing members. Similarly, the lifting plate and/or its supporting arms may be connected to the base part of the chassis or the second cross member.

The illustrated mixers are arranged to be fitted to an excavator arm, but it is conceivable that the mixer could instead be adapted to fit to other plant, such as a telescopic handler or a crane. If necessary, the chassis of the mixer could incorporate one or more pivoting boom sections so that one or more of the manoeuvres required during operation of the mixer can be performed by the mixer rather than by the plant. It is also possible that the mixer could be provided as a dedicated, stand-alone machine having its own cab and arm.

While the illustrated embodiments of the mixer are configured for use with a FIBC, it is also conceivable that the mixer of the invention could be used with other types of container, including rigid containers.

The FIBC or other container can be pre-filled with any suitable components. As is known in the art, the aggregate mix may comprise a mixture of fine and coarse aggregates, such as sand and crushed stone or gravel. The chemical admixtures may include additives such as plasticisers, accelerating and/or retarding compounds, water-reducing compounds, corrosion inhibitors, air-entraining additives, workability enhancers and so on.

A suitable quantity of water can be added to the container before attachment of the container to the mixer, or the water could be added to the mixing drum after transfer of the material from the container. It is also possible to spray or otherwise soak the mixed concrete in water in situ after it has been laid.

Further modifications and variations not explicitly described above are also possible without departing from the scope of the invention as defined by the appended claims.

1. A mixer for mixing concrete components, comprising:
a chassis; and
a mixing drum mounted for rotation with respect to the chassis and having an open end;
the chassis including a lifting structure extending beyond the open end of the drum and a support structure spanning the open end of the drum;
the mixer being moveable between an inverted orientation in which the open end of the mixing drum faces generally downwards and a mixing orientation in which the open end of the mixing drum faces generally upwards;
wherein the lifting structure is arranged to engage with a container with the mixer in the inverted orientation, and to lift and invert the container upon movement of the mixer to the mixing orientation;
and wherein the support structure is arranged to support the inverted container above the mixing drum when the mixer is in the mixing orientation and to allow material to pass from the container into the mixing drum.

2. A mixer according to claim 1, wherein the chassis comprises at least one attachment point for attachment to the container.

3. A mixer according to claim 2, wherein the or each attachment point is disposed on an opposite side of the drum to the lifting structure.

4. A mixer according to claim 2, comprising a pair of attachment points spaced apart laterally on a cross-member of the chassis.

5. A mixer according to claim 2, wherein the or each attachment point is disposed on the lifting structure.

6. A mixer according to claim 5, wherein the lifting structure comprises a lifting frame disposed at the open end of the mixing drum, and wherein the or each attachment point is disposed on the lifting frame.

7. A mixer according to claim 2, wherein the container comprises a flexible intermediate bulk container and wherein the or each attachment point is configured to attach to a lifting loop of the container.

8. A mixer according to claim 7, wherein the chassis comprises guide members for supporting the lifting loops of the container to keep the container in an open configuration.

9. A mixer according to claim 1, wherein the lifting structure comprises a curved plate for engaging a side of the container.

10. (canceled)

11. A mixer according to claim 9, wherein the lifting structure comprises a ramp for deflecting material from the plate into the mixing drum.

12. (canceled)

13. A mixer according to claim 1, wherein the lifting structure comprises a lifting foot for engaging a base of the container.

14. A mixer according to claim 1, wherein the support structure comprises a framework defining apertures through which the material can pass from the container into the mixing drum.

15. A mixer according to claim 1, wherein the chassis comprises an attachment configured to connect to an excavator arm.

16. An excavator comprising an excavator arm fitted with a mixer, the mixer comprising:
a chassis; and
a mixing drum mounted for rotation with respect to the chassis and having an open end;
the chassis including a lifting structure extending beyond the open end of the drum and a support structure spanning the open end of the drum;
the mixer being moveable between an inverted orientation in which the open end of the mixing drum faces generally downwards and a mixing orientation in which the open end of the mixing drum faces generally upwards;
wherein the lifting structure is arranged to engage with a container with the mixer in the inverted orientation, and to lift and invert the container upon movement of the mixer to the mixing orientation;
wherein the support structure is arranged to support the inverted container above the mixing drum when the mixer is in the mixing orientation and to allow material to pass from the container into the mixing drum;
and wherein the chassis comprises an attachment configured to connect to the excavator arm and the mixer is attached to the excavator arm by way of the attachment.

17. A method for making a concrete mix, comprising:
engaging a mixer with a container containing cement and aggregate components of a concrete mix;
manoeuvring the mixer to lift and invert the container using a lifting structure of the mixer, thereby to transfer the components into a mixing drum of the mixer; and
rotating the mixing drum to mix the components.

18. (canceled)

19. The method of claim 17, wherein the container comprises a flexible intermediate bulk container, and wherein engaging the mixer with the container comprises connecting at least one lifting loop of the container to the mixer.

20. The method of claim 17, wherein lifting the container comprises moving the container onto a support structure that spans an open end of the mixing drum.

21. The method of claim 17, comprising, after transferring the components, removing the container from the mixer.

22. The method of claim 17, comprising, after mixing the components, manoeuvring the mixer to invert the mixing drum, thereby to discharge the concrete mix.

23. The method of claim 17, wherein the mixer is manoeuvred using an excavator arm.
